(19) United States
(12) Patent Application Publication
(10) Pub. No.: US 2008/0298736 A1
(43) Pub. Date: Dec. 4, 2008

(54) Broadband Electro-Optic Polymer Modulators With Integrated Resistors

(75) Inventors: Mary K. Koenig, Seattle, WA (US); Guomin Yu, Bothell, WA (US)

Correspondence Address: FISH & RICHARDSON P.C., PO BOX 1022, MINNEAPOLIS, MN, 55440-1022, US

(73) Assignee: Lumera Corporation, Bothell, WA (US)

(21) Appl. No.: 11/757,898

(22) Filed: Jun. 4, 2007

(51) Int. Cl. G02F 1/035

(52) U.S. Cl. 385/2

(57) ABSTRACT

In one aspect, an electro-optic device comprises: a) a high speed electrode; b) a ground electrode; c) polymer layers embedding an electro-optic polymer waveguide; and d) at least one integrated resistor in electrical contact with the high speed electrode and the ground electrode, wherein the high speed electrode and the ground electrode are positioned to control light in the electro-optic polymer waveguide.

### BACKGROUND

High frequency devices may oscillate when terminated with an open circuit or short circuit. For this reason, some devices in high speed systems such as high speed data communications or satellite communications are terminated with the characteristic impedance of the system specified. A common device termination is a 50 ohm resistor. In some devices, the termination resistor is made discretely as either a thin or thick film of tungsten on a ceramic, diced to a small size, and placed and bonded as a discrete component to the high frequency device. Since this component is not an ideal resistor it can be considered as a resistor with shunt parasitic capacitance and series parasitic inductance. These parasitic properties of the resistor may limit the operating bandwidth of the device. Additionally, discrete resistors are in some cases difficult to handle, place, and bond to the finished device, which raises manufacturing costs. Termination with discrete resistors is especially problematic with electro-optic polymer modulators, where the bonding agents may damage the polymer layers before and/or after curing.

### SUMMARY

In one aspect, an electro-optic device comprises: a) a high speed electrode; b) a ground electrode; c) polymer layers embedding an electro-optic polymer waveguide; and d) at least one integrated resistor in electrical contact with the high speed electrode and the ground electrode, wherein the high speed electrode and the ground electrode are positioned to control light in the electro-optic polymer waveguide.

In another aspect, an electro-optic device comprises: a) a substrate; b) polymer layers embedding an electro-optic polymer waveguide; c) a high speed electrode formed from a deposited layer and positioned generally parallel to the polymer layers and so that control is provided between electrical signals propagating in the high speed electrode and optical signals propagating in the optical waveguide; d) a ground electrode formed from a deposited layer and spaced apart from the high speed electrode; and e) a resistive material structure formed from a deposited layer connecting the high speed electrode and the ground electrode.

In various implementations, one or more of the following features may be present. The high speed electrode and the ground electrode may be formed from the same deposited layer. The layer from which the resistive material structure is formed may be a different layer than the layer from which the high speed electrode and the ground electrode are formed. The layer from which the resistive material structure is formed may reside between the polymer layers and the layer from which the high speed electrode and the ground electrode are formed. The layer from which the resistive material structure is formed may reside adjacent to the polymer layers and adjacent to the layer from which the high speed electrode and the ground electrode are formed. The layer from which the resistive material structure is formed may comprise a material that provides adhesion between the layer from which the high speed electrode and the ground electrode are formed and the polymer layers.

In another aspect, a process comprises: a) fabricating polymer layers embedding an electro-optic polymer waveguide; b) fabricating a high speed electrode and a ground electrode, wherein the high speed electrode and ground electrode are positioned to control the electro-optic polymer waveguide; and c) fabricating a resistor at a predetermined location along the high speed electrode. In yet another aspect, a process comprises: a) depositing a metal layer on polymer layers embedding an electro-optic polymer waveguide, the metal layer having a predetermined sheet resistance; b) depositing a gold layer on the metal layer; c) etching a high speed electrode and a ground electrode in the gold layer, thereby exposing a portion of the metal layer; and d) etching at least one resistor in the exposed portion of the metal layer, thereby forming an exposed portion of the polymer layers, wherein the resistor is in electrical contact with the high speed electrode and the ground electrode.

The details of one or more embodiments are set forth in the accompanying drawings and the description below. Other features and advantages will be apparent from the description and drawings, and from the claims.

### BRIEF DESCRIPTION OF THE DRAWINGS

FIGS. 1a-c are diagrams of an embodiment of an electro-optic device that comprises integrated resistors.

FIGS. 2a-c are diagrams of another embodiment of an electro-optic device that comprises integrated resistors.

FIGS. 3a-c are diagrams of yet another embodiment of an electro-optic polymer device including integrated resistors.

FIGS. 4a-c are diagrams of a further embodiment of an electro-optic polymer device including integrated resistors.

FIG. 5 is a diagram of an electro-optic device that includes a Mach-Zehnder modulator and integrated resistors.

FIGS. 6a-e are diagrams of an electro-optic device with integrated resistors, illustrating steps of manufacturing the device.

### DETAILED DESCRIPTION

In one aspect, an electro-optic device comprises: a) a high speed electrode; b) a ground electrode; c) polymer layers embedding an electro-optic polymer waveguide; and d) at least one integrated resistor in electrical contract with the high speed electrode and the ground electrode, wherein the high speed electrode and the ground electrode are positioned to control light in the electro-optic polymer waveguide. An integrated resistor, in one implementation, is a resistor that is formed in contact with the high speed electrode and the ground electrode as part of the on-wafer fabrication process of the electro-optic device chips. The resistor may, in some implementations, underlie any layers of the device or be on the surface. Processes used to fabricate the integrated resistor can include, for example, electroplating, photolithography, wet or dry etching, and/or thin film sputtering/evaporation.

Electro-optic polymer waveguides are known and include devices that have either an electro-optic polymer core, an electro-optic polymer clad/s, or both and passive polymer clads, passive inorganic (e.g., Si or SiOₓ) clads, passive polymer cores, and passive inorganic cores, and any combination thereof, for example see U.S. Pat. Nos. 6,716,995; 6,937,811; 7,016,555; and 7,161,726. Typically, the electro-optic polymer waveguide comprises an electro-optic polymer core and at least two passive polymer clads. The high speed electrode and the ground electrode can be in either a microstrip or a coplanar configuration. The location of the resistor along the high speed electrode and the ground electrode may be different from the location where the high speed electrode and the ground electrode control light in the electro-optic polymer waveguide. Examples of electro-optic devices that may include a high speed electrode are Mach-Zehnder interferometer optical intensity modulators, phase modulators, directional coupler modulators and switches, and micro-ring resonators.

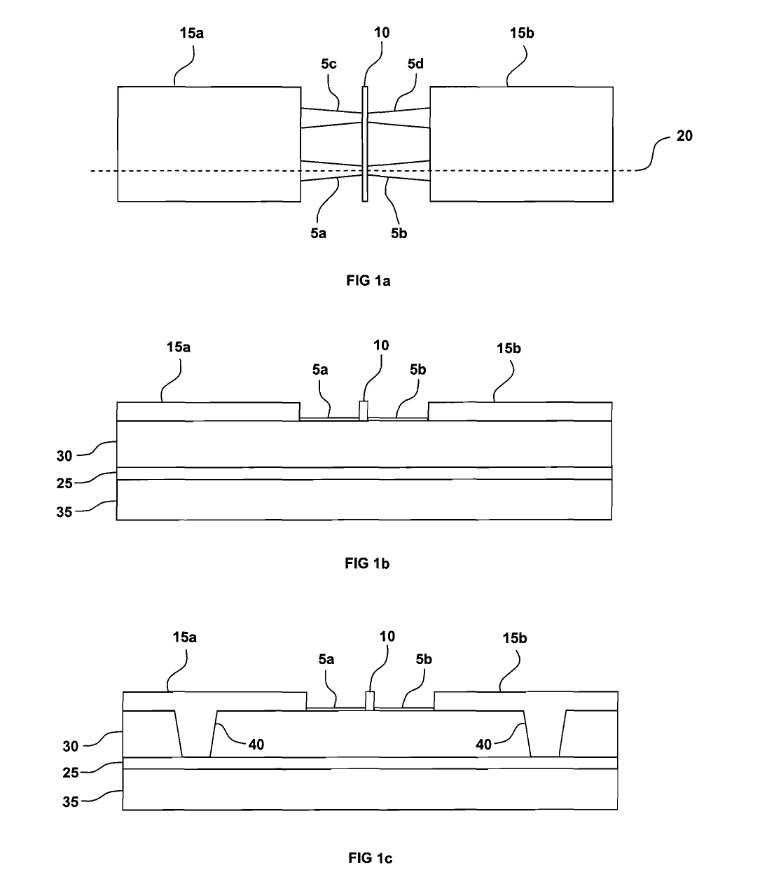

Referring to FIG. 1a, an example electro-optic device 2 comprises at least four integrated resistors 5a-d. Each of the four resistors is in contact with both a high speed electrode 10 and one of two ground electrodes 15a, 15b. In the illustrated embodiment, the resistors are arranged in parallel. Typically, each of the four resistors have substantially the same resistance, and, when combined, they match the characteristic impedance of the system in which the electro-optic device is inserted. For example, to match a system with a 50 ohm characteristic impedance, the four resistors 5a-b may each have a resistance of 200 ohms. The combined resistance of the parallel integrated resistors may be from 2 times to 0.5 times the characteristic impedance of a system that includes the electro-optic device. In these systems, up to a 2 to 1 ohm mismatch between the system and the electro-optic device, or vice versa, will still give an electrical return loss (S11) within a −10 dB specification. For example, if a device is inserted into a system with a characteristic impedance of 50 ohms, the device may have resistors that terminate the device at anywhere between 100 and 25 ohms and still meet a −10 dB electrical return loss specification. The electro-optic device may be further characterized as having a predetermined bandwidth, wherein a first pair 5a, 5b of the four resistors are at a first point along the high speed electrode and a second pair 5c, 5d of the four resistors are at a second point along the high speed electrode, wherein the distance measured along the high speed electrode between the first point and the second point is about one quarter wavelength of the predetermined bandwidth.

Referring to FIG. 1b, which is a cross sectional view of the device 2 shown in FIG. 1a in plane 20 that is perpendicular to the plane of the page, the ground electrode 15a, 15b of the electro-optic device is in electrical contact with a ground plane 25, wherein the ground electrode 15a and the high speed electrode 10 are coplanar in a first plane, and wherein the ground plane and the first plane are substantially parallel and separated by polymer layers 30 embedding an electro-optic polymer waveguide. Such a ground electrode-ground plane structure, when combined with transitions of the high speed electrode in another area of the device, may provide efficient RF coplanar to microstrip transitions, for example, see U.S. Pat. No. 7,197,222. For clarity in FIG. 1b and others in this document, the polymer layers 30 of the electro-optic polymer waveguide are shown as one uniform layer unless otherwise noted. A substrate 35 may underlie the ground electrode. Electrical contact between the ground electrode and the ground plane can be made, for example, by depositing conductive material along an edge of the chip where the ground electrode and ground plane are exposed, by etching a via 40 (FIG. 1c) through the polymer layers, or by mechanically removing the polymer layers in a small area. The integrated resistors 5a-d may comprise a metal or metal alloy having a sheet resistance of 120-200 ohm/square. Examples of metals or metal alloys that may be used for the resistor include Ti, NiCr, TiO₃, Ta, TaO₅, Ni, Cr, TiW, and W. The bandwidth of the electro-optic device may be at least 10 GHz or 30 GHz. The resistors 15a-d may each taper from the ground electrode 15a, 15b to the high speed electrode 10 in order to more precisely space the resistors at one-quarter the wavelength of the bandwidth.

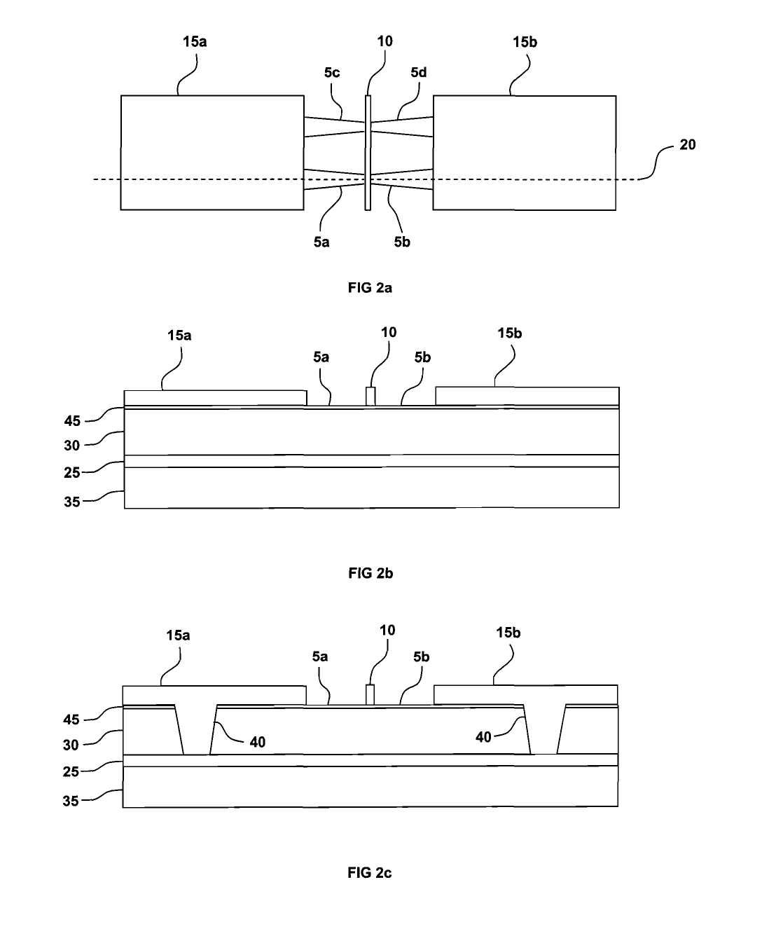

In another embodiment, referring to FIGS. 2a-c, the resistors 5a-5d comprise a metal layer 45 underlying both the high speed electrode 10 and the ground electrode 15a, 15b, and overlying the polymer layers 30. The metal layer 45 may promote adhesion between the polymer layers 30 and the high speed electrode 10 and/or the ground electrode 15a, 15b.

In another aspect, an electro-optic device comprising: a) a substrate; b) polymer layers embedding an electro-optic polymer waveguide; c) a high speed electrode formed from a deposited layer and positioned generally parallel to the polymer layers and so that control is provided between electrical signals propagating in the high speed electrode and optical signals propagating in the optical waveguide; d) a ground electrode formed from a deposited layer and spaced apart from the high speed electrode; and e) a resistive material structure formed from a deposited layer connecting the high speed electrode and the ground electrode.

In various implementations, one or more of the following features may be present. The high speed electrode and the ground electrode may be formed from the same deposited layer. The layer from which the resistive material structure is formed may be a different layer than the layer from which the high speed electrode and the ground electrode are formed. The layer from which the resistive material structure is formed may reside between the polymer layers and the layer from which the high speed electrode and the ground electrode are formed. The layer from which the resistive material structure is formed may reside adjacent to the polymer layers and adjacent to the layer from which the high speed electrode and the ground electrode are formed. The layer from which the resistive material structure is formed may comprise a material that provides adhesion between the layer from which the high speed electrode and the ground electrode are formed and the polymer layers. The layer from which the resistive material structure is formed may comprise titanium. The resistive material structure provides termination of the high speed electrode at a selected characteristic impedance. The selected characteristic impedance may be about 50 ohms.

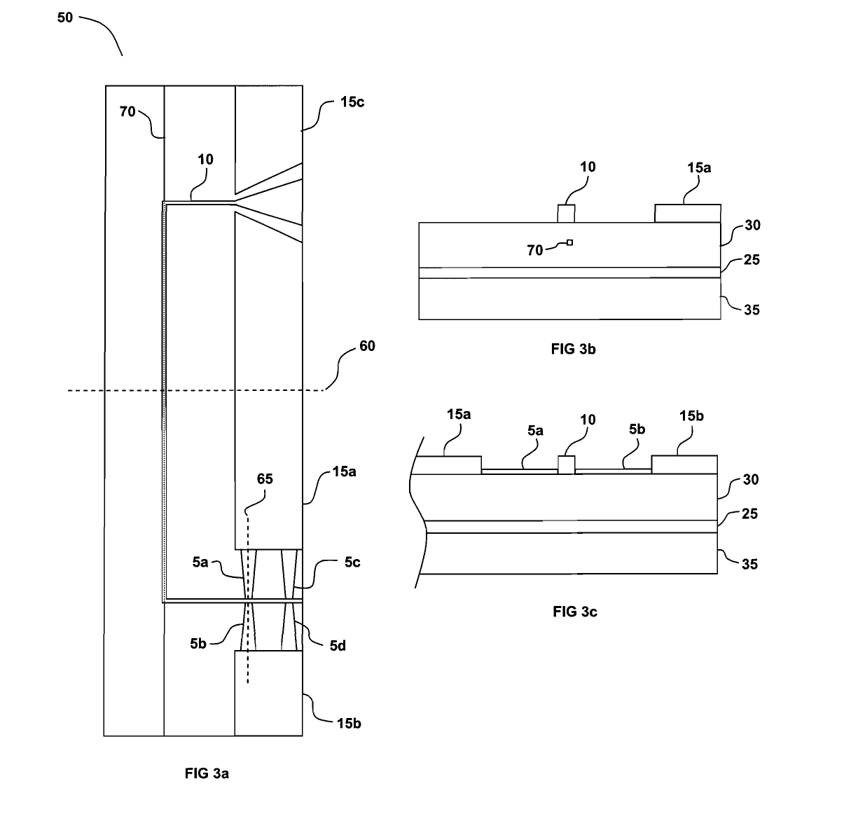

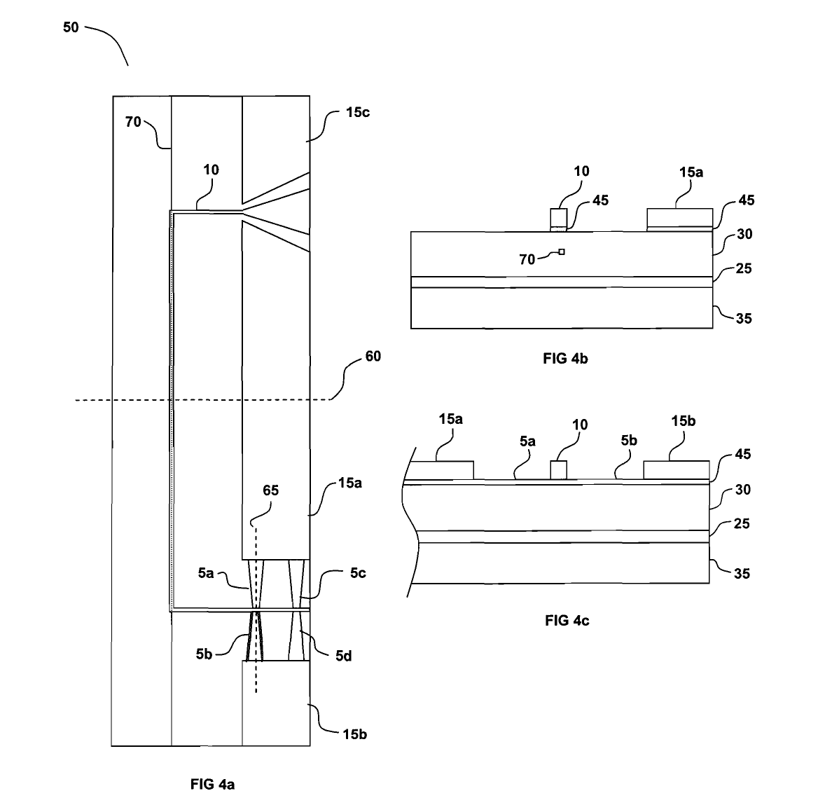

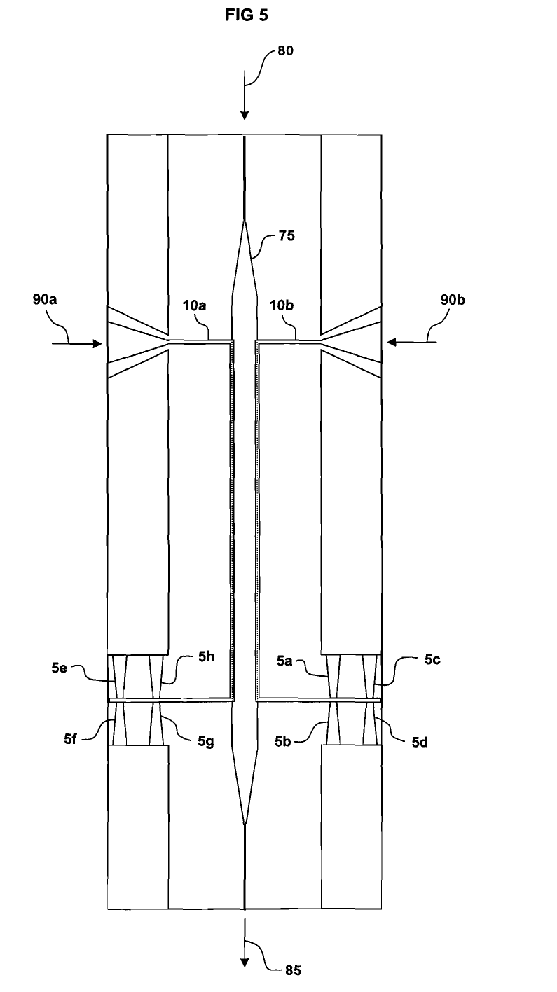

In yet another embodiment, referring to FIGS. 3a-c, an electro-optic device 50 comprises a) substrate 35 (shown in FIG. 3b, which is a cross sectional view in plane 60 that is perpendicular to the plane of the page, and in FIG. 3c, which is a cross sectional view in plane 65 perpendicular to the plane of the page) b) polymer layers 30 embedding an electro-optic polymer waveguide 70; c) a high speed electrode 10 formed from a deposited layer and positioned generally parallel to the polymer layers 30 and so that control is provided between electrical signals propagating in the high speed electrode 10 line and optical signals propagating in the electro-optic polymer waveguide 70; d) a ground electrode 15a-c formed from a deposited layer and spaced apart from the high speed electrode 10; and e) four resistors 5a-d formed from a deposited resistive material layer connecting the high speed electrode 10 and the ground electrode 15a, 15b. The device may further comprise a ground plane 25 as described above. Note that in the embodiment illustrated in FIG. 1b, the electro-optic core of the electro-optic polymer waveguide is located in different area of the device from the resistors 5a-d. In the electro-optic polymer waveguide section of the device (e.g., plane 60) the electric field extends between the high speed electrode and the ground plane so that the electrical-optical overlap is near unity. In another embodiment, referring to FIG. 4a-c, the deposited resistive material layer from which the resistors 15a-d are formed is located between the polymer layers 30 and both the high speed electrode 10 and the ground electrode 15a, 15b. The deposited resistive material layer may promote adhesion between the polymer layers 30 and the high speed electrode 10 and/or the ground electrode 15a, 15b.

The electro-optic polymer waveguide device illustrated in FIGS. 3a-c and FIGS. 4a-c may be a subpart of a larger electro-optic device or optical component (e.g., a transponder or transceiver). One such larger electro-optic device is shown in FIG. 5, which illustrates a Mach-Zehnder interferometer 75 with a light input 80 and a light output 85 that has two high speed electrodes 10a, 10b. High speed electrode 10a has four integrated resistors 5a-d and high speed electrode 10b has four integrated resistors 5e-h. Each high speed electrode has an electrical input 90a, 90b. The two high speed electrodes 10a, 10b can control independently the light in the two Mach-Zehnder arms, which can be used, for example, to run the device in a push-pull configuration, to run the device in an unbalanced manner to control chirp, or to use one or both electrodes to manipulate the bias point concurrently with a high speed radio frequency (RF) signal.

In another aspect, a process comprises: a) fabricating polymer layers embedding an electro-optic polymer waveguide; b) fabricating a high speed electrode and a ground electrode, wherein the high speed electrode and ground electrode are positioned to control the electro-optic polymer waveguide; and c) fabricating a resistor at a predetermined location along the high speed electrode. A high resistivity silicon wafer, which may additionally have a SiOₓ surface, may be used as a substrate. The fabrication steps need not be in the order described above. In some cases, some steps of one or more of the fabrication processes may occur before another/other fabrication step/s is/are started, and then finished after the other fabrication step/s is/are complete. For example, part of the high speed electrode and ground electrode may be fabricated before the polymer layers embedding the electro-optic polymer waveguide, then after the polymer layers are complete, part of the resistor may be fabricated next, then the rest of high speed electrode and the ground electrode may be completed before the resistor is completed. In another example, the polymers layers embedding an electro-optic polymer waveguide may be fabricated on the substrate before the high speed electrode, the ground electrode, and the resistor. In another example, the high speed electrode and ground electrode, or any part thereof, may be fabricated on the substrate before the polymer layers embedding an electro-optic polymer waveguide. In various implementations, one or more of the following features may be present. The high speed electrode may be fabricated before the resistor or after the resistor. Fabricating the resistor may comprise depositing a metal layer by evaporation, sputtering, screen printing, electroplating, sol gel deposition, or spin coating, the metal layer being characterized as having a predetermined sheet resistance. The sheet resistance will depend on the several factors including the conductivity and thickness of the metal layer. The sheet resistance is 120-200 ohm/square. The high speed electrode may comprise a microstrip. The metal layer may be deposited before fabrication of the high speed electrode. The resistor may be completed after the high speed electrode is completed, or before the high speed electrode is completed.

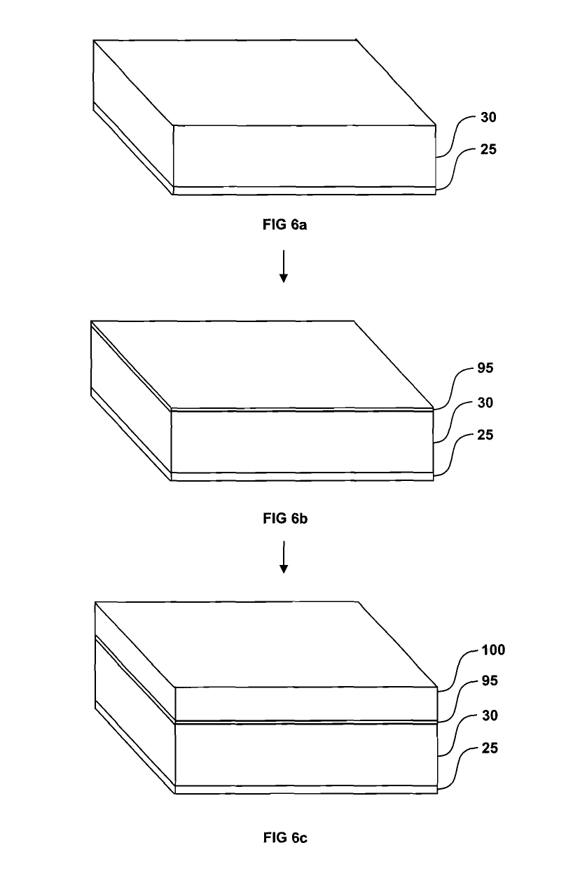

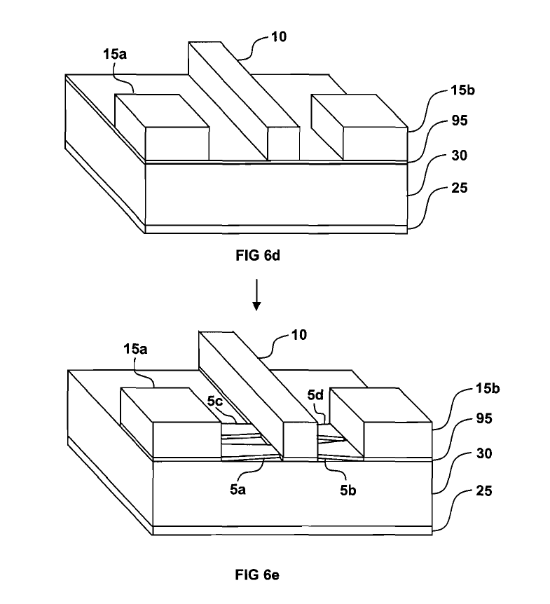

Referring to FIGS. 6a-e, a process for manufacturing an electro-optic device comprises: a) depositing a metal layer 95 (FIG. 6b) on polymer layers 30 embedding an electro-optic polymer waveguide, the metal layer 95 having a predetermined sheet resistance; b) depositing a gold layer 100 (FIG. 6c) on the metal layer; c) etching a high speed electrode 10 and a ground electrode 15a, 15b in the gold layer (FIG. 6d), thereby exposing a portion of the metal layer 95; and d) etching at least one resistor (any one of 15a-d, FIG. 6e) in the exposed portion of the metal layer 95, thereby forming an exposed portion of the polymer layers 30, wherein the resistor is in electrical contact with the high speed electrode 10 and the ground electrode 15a, 15b. A gold ground plane 25 may underlie the polymers layers 30. The metal layer may promote adhesion between the polymer layers 30 and the gold layer 100. Another embodiment is a process, comprising: a) fabricating a gold ground plane on a substrate; b) fabricating an electro-optic polymer waveguide comprising a bottom polymer clad, and electro-optic polymer core, and a top polymer clad; c) depositing on the top polymer clad a metal layer having a predetermined sheet resistance; d) depositing a gold layer on the metal layer e) fabricating a high speed microstrip electrode and a ground electrode from the gold layer; and f) fabricating a resistor from the metal layer, wherein the metal layer promotes adhesion between the top polymer clad and the gold layer. Other embodiments include electro-optic devices made by any of the processes described above.

Another aspect is an array of electro-optic polymer modulators, where more than one of the electro-optic polymer modulators in the array has an integrated resistor. The integrated resistor may be as described above.

### EXAMPLES

The following example(s) is illustrative and does not limit the Claims.

A Mach-Zehnder modulator was fabricated with a high speed electrode in the microstrip configuration. The RF input of the electrode was like that shown in FIG. 3a and FIG. 4a. Four parallel resistors were fabricated as shown in FIG. 1a. The width of each resistor at the junction with the ground electrode was 0.2 mm and the width of each resistor at the junction with the high speed electrode was 0.1 mm. The length of each resistor was 228 mm. Each resistor had a nominal resistance of 200 Ohms, which combined gave a termination for the device of approximately 50 Ohms. The first pair of resistors was spaced 1.15 mm from the second pair of resistor along the high speed electrode. The gold ground plane was sputter deposited on a high resistivity Si wafer. The polymer layers embedding an electro-optic polymer waveguide were fabricated as follows: a) a bottom clad polymer was spin deposited and cured; b) a Mach-Zehnder interferometer trench was dry etched into the bottom clad polymer after photoresist deposition/photoexposure/developing; c) following stripping of the photoresist, the trench was backfilled by spin depositing an electro-optic polymer on the bottom clad layer; d) a top clad polymer was spin deposited on the electro-optic polymer and cured to provide the polymers layers embedding the electro-optic polymer waveguide. A poling electrode was then sputtered deposited on the surface of the polymer stack, and patterned using photolithography and a wet chemical etch. The device was then poled, and the poling electrode was then removed using a wet chemical process. A titanium layer, from which the resistors were fabricated, was deposited in multiple sputtering cycles to avoid wrinkling. Each sputtering cycle consisted of pre-sputtering, sputtering and venting. The Ti film was deposited by a) pre-sputtering for 100 sec; b) sputtering for 150 sec; c) auto-venting for 30 sec; d) pre-sputtering for 50; e) sputtering for 145 sec; and f) venting. The thin film was 30 nm thick and had a sheet resistance of 160 Ohm/square. A 170 nm seed layer of gold was deposited on the Ti film. A layer of photoresist was then patterned on the surface to leave just the high speed electrode and the ground electrode areas exposed. The high speed electrode and the ground electrode were then electro-plated to a thickness of 5.0 microns, and the photoresist was stripped to leave the seed Au layer exposed in the areas that were not electroplated. The seed Au was then removed in these areas using a wet etch, leaving behind the blanket Ti layer. The Ti resistors were patterned by photoresist deposition/photoexposure/developing followed by dry etching with an O₂, SF₆, and Ne gas mixture (10:40:5) at 20 mTorr for 4 min. The photoresist was stripped, and the wafer was diced to give Mach-Zehnder electro-optic polymer intensity modulators with integrated Ti resistors. The devices were tested up to 20 GHz and gave an electrical return loss (S11) less than −10 dB.

Other embodiments are within the following claims.

1. An electro-optic device, comprising: a) a high speed electrode; b) a ground electrode; c) polymer layers embedding an electro-optic polymer waveguide; and d) at least one integrated resistor in electrical contract with the high speed electrode and the ground electrode, wherein the high speed electrode and the ground electrode are positioned to control light in the electro-optic polymer waveguide.

2. The electro-optic device of claim 1, comprising at least four parallel integrated resistors.

3. The electro-optic device of claim 2, wherein the combined resistance of the parallel integrated resistors is from 2 times to 0.5 times the characteristic impedance of a system that includes the device.

4. The electro-optic device of claim 2, wherein a first pair of the resistors are at a first point along the high speed electrode and a second pair of the resistors are at a second point along the high speed electrode, wherein the distance measured along the high speed electrode between the first point and the second point is about one quarter wavelength of a predetermined bandwidth for the device.

5. The electro-optic device of claim 4, wherein the ground electrode is in electrical contact with a ground plane, wherein high speed electrode and the ground electrode are coplanar in a first plane, and wherein the ground plane and the first plane are substantially parallel and separated by the polymer layers embedding an electro-optic polymer waveguide.

6. The electro-optic device of claim 5, wherein the electro-optic polymer waveguide is between the first plane and the ground plane.

7. The electro-optic device of claim 5, wherein the integrated resistor comprises a metal or metal alloy having a sheet resistance of 120-200 ohm/square.

8. The electro-optic device of claim 7, wherein the metal or metal alloy is Ti, NiCr, TiO₃, Ta, TaO₅, Ni, Cr, TiW, or W.

9. The electro-optic device of claim 5, wherein the bandwidth is at least 10 GHz.

10. The electro-optic device of claim 5, wherein the bandwidth is at least 30 GHz

11. The electro-optic device of claim 5, wherein the resistors are in electrical contact with the high speed electrode and the ground electrode.

12. The electro-optic device of claim 11, wherein the resistors each taper from the ground electrode to the high speed electrode.

13. The electro-optic device of claim 11, wherein the resistors comprise a metal layer underlying both high speed electrode and the ground electrode, and overlying the polymer layer embedding an electro-optic polymer waveguide.

14. The electro-optic device of claim 13, further comprising a polymer layer between the metal layer and the ground plane, wherein the polymer layer is in contact with the metal layer, and the metal layer promotes adhesion between the polymer layer and the ground electrode or the high speed electrode.

15. An electro-optic device comprising: a) a substrate; b) polymer layers embedding an electro-optic polymer waveguide; c) a high speed electrode formed from a deposited layer and positioned generally parallel to the polymer layers and so that control is provided between electrical signals propagating in the high speed electrode and optical signals propagating in the optical waveguide; d) a ground electrode formed from a deposited layer and spaced apart from the high speed electrode; and e) a resistive material structure formed from a deposited layer connecting the high speed electrode and the ground electrode.

16. The electro-optic device of claim 15, wherein the high speed electrode and the ground electrode are formed from the same deposited layer.

17. The electro-optic device of claim 16, wherein the layer from which the resistive material structure is formed is a different layer than the layer from which the high speed electrode and the ground electrode are formed.

18. The electro-optic device of claim 17, wherein the layer from which the resistive material structure is formed resides between the polymer layers and the layer from which the high speed electrode and the ground electrode are formed.

19. The electro-optic device of claim 18, wherein the layer from which the resistive material structure is formed resides adjacent to the polymer layers and resides adjacent to the layer from which the high speed electrode and the ground electrode are formed

20. The electro-optic device of claim 19, wherein the layer from which the resistive material structure is formed comprises a material that provides adhesion between the layer from which the high speed electrode and the ground electrode are formed and the polymer layers.

21. The electro-optic device of claim 20, wherein the layer from which the resistive material structure is formed comprises titanium.

22. The electro-optic device of claim 15, wherein the resistive material structure provides termination of the high speed electrode at a selected characteristic impedance.

23. The electro-optic device of claim 22, wherein the selected characteristic impedance is about 50 ohms.
